(19) United States
(12) Patent Application Publication
(10) Pub. No.: US 2018/0004546 A1
(43) Pub. Date: Jan. 4, 2018

(54) UTILIZING A LOCAL DEVICE KEYBOARD IN A REMOTE DESKTOP ENVIRONMENT

(71) Applicant: Avast Software s.r.o., Prague (CZ)

(72) Inventors: Jose Luis Ferras Pereira, San Mateo, CA (US); David Chih-Yuan Chen, Sunnyvale, CA (US); Serdar Onal, Redwood City, CA (US)

(21) Appl. No.: 15/637,876

(22) Filed: Jun. 29, 2017

Related U.S. Application Data
(60) Provisional application No. 62/356,367, filed on Jun. 29, 2016.

(51) Int. Cl. G06F 9/44; G06F 3/0488

(52) U.S. Cl. CPC G06F 9/4445; G06F 3/04886

(57) ABSTRACT

A keyboard for a remote device on a client device is provided. In a method of the present invention, an indication is received that a keyboard is needed for the remote device by a client device communicably coupled to the remote device. In response to receiving the indication, the client device opens a soft keyboard. Text received on the soft keyboard is transmitted text received via the soft keyboard on the client device to the remote device. Thus, a user can utilize a preferred keyboard on their own device while accessing applications on a remote device.

### CROSS-REFERENCE TO RELATED APPLICATIONS

This Application claims priority to U.S. Provisional Patent Application Ser. No. 62/356,367, filed on Jun. 29, 2016, entitled “Utilizing a Logical Device Keyboard in a Remote Desktop Environment,” currently pending, the entire disclosure of which is incorporated herein by reference.

### FIELD OF INVENTION

The present invention relates generally to mobile computing systems, and more particularly, utilizing a local device keyboard in remote desktop system environments.

### BACKGROUND OF INVENTION

With the advancements in mobile phone and cellular network technology, people are spending more time on mobile devices such as smart phones and tablets instead of laptops and desktops. This shift in user behavior impacts how various tasks are performed on mobile devices and one of such important task is typing on mobile devices.

A soft keyboard, sometimes referred to as software keyboard or onscreen keyboard, is a replacement of the hardware keyboard on the computing device using an on-screen mapping of the keyboard. In the current market, the majority of the smart phones and tablets utilize the soft keyboard instead of having a physical hardware keyboard on the mobile device, which effectively reduces the number of hardware components required as well as the overall device weight.

In addition to the switch to the soft keyboard from the physical keyboard, mobile devices also implement numerous technologies to help and support a better typing experience for the users. Such technologies may include, but not limited to, predictive text input, auto-correction, auto-completion, and auto-replacements of texts. These assistive typing technologies that complement the soft keyboard are indispensable in today's mobile device world since it brings forth a much easier and efficient typing experience for the users.

Keyboard usage and typing becomes a challenge, however, for remote access to other mobile devices. Traditional approaches, when remotely accessing a mobile device from another mobile device, require that the remote keyboard (the keyboard on the remote host) is used instead of the local device soft keyboard. Typing issues may arise due to the fact that the user is not accustomed to the remote keyboard as it probably has a different appearance and behavior. In fact, if the local and remote devices' Operating Systems differ, the overall user experience model is different as well, typically confusing users which ultimately can bring user engagement consequences in the long run.

Another concern with using the remote soft keyboard instead of the local one on the mobile device is that there will be either delayed or no haptic feedback due to network latency or bad network conditions, making typing further difficult. Furthermore, most soft keyboard implementations use a trained dictionary that is customized for that user to provide suggestions, auto-corrections and auto-completions that the user is already familiar with. With the traditional approach, users cannot leverage these functionalities when using the remote keyboard, eventually frustrating the user and degrading overall user experience.

### SUMMARY OF THE INVENTION

One objective of the present invention is to provide a virtual keyboard in a remote environment, especially, for remotely accessing and typing on remote devices or applications. One embodiment of the present invention is directed to a method for providing a keyboard for a remote device. A network connection may be established between a remote device and a client device when a user opens an application. The user accessing the remote connection may be authenticated through a remote server coupled to the client device. The client device can provide authentication information to a remote server, such as user login credentials. This can be accomplished, for example, by sending a streaming request to the remote server for interacting with an application executed on the remote device.

When beginning an interaction on the virtual keyboard, the remote device can receive an indication that a keyboard is needed for the remote device. The remote device keyboard may relay information about an activated text field to the local device instead of showing a standard keyboard user interface on the remote device. In response to receiving the indication, the client device opens a client device keyboard configured with appropriate input options. The client device may send to the remote device position and dimension information for the soft keyboard on the client device. The remote device can then create or otherwise establish a remote overlay view in accordance with the position and dimension information, wherein the remote overlay view is configured to display the soft keyboard of the client device. A local text field may be created on the client device that mirrors a remote text field on the remote device. It will be appreciated that the local text field may be hidden from display. The text received via the soft keyboard on the client device is transmitted to the remote device. The content of the local text field can be synchronized with the content of the remote text field. This step of synchronizing the content of the local text field and the content of the remote text field may be accomplished by applying differential synchronization algorithms, operational transformation algorithms, or both, to the local text field and the remote text field. When the remote device receives an indication of the user has finished a text editing procedure, the client device can finish the process by closing the virtual keyboard.

Another aspect of the present invention is directed to a system for providing a virtual keyboard in a remote network connection environment. The system can generally include a client device, a remote device, and a remote server. The client device can have a computing processor operable to display a local keyboard image coupled to the remote network connection. The client device may further comprise a remote display for displaying the contents of a screen of the remote device, and a remote text field providing menu buttons on the remote display. The client device can also comprise a local text field, wherein the local text field is synchronized with the remote text field. The local text field can have at least one of a scaler, matrices, and image mirrors coupled with the remote server. The remote device includes a computing processor and an application for executing remote access the virtual keyboard coupled to the remote network connection. A remote device keyboard relays text field information to the client device. The remote server may store an instance associated with a specific user and provide the remote device with such instance.

Another embodiment of the present invention relates to a non-transitory computer readable storage medium having a program for providing a keyboard for a remote device. The program is adapted to establishing a network connection between a remote device and a client device, and facilitating the transmission of authentication information to a remote server for the user access security. When beginning an interaction on the virtual keyboard, the remote device receives an indication that a keyboard is needed for the remote device. Responding to the indication of the remote device, the client device opens the client device keyboard with configuring appropriate input options. After indicating the client keyboard opening process, the remote device may send an initial state of a remote text field date, and the client device may transmit the text received via the soft keyboard on the client device to the remote device. Position and dimension information for the soft keyboard on the client device may be received by the remote device. A remote overlay view may be established on the remote device in accordance with the position and dimension information. The remote overlay view may be configured to display the soft keyboard of the client device. Finally, if the remote device receives an indication that the user is finished with the text editing procedure, the client device can finish the process by closing the virtual keyboard.

### BRIEF DESCRIPTION OF THE DRAWINGS

For a better understanding of the disclosure, reference may be made to the accompanying drawings in which:

FIG. 1 is a schematic diagram illustrating a system for providing a local keyboard on a local device for use in accessing a remote device in accordance with one embodiment of the present invention;

FIG. 2 is a sequence diagram illustrating initiation of a soft keyboard session and termination of the session in accordance with one embodiment of the present invention;

FIG. 3A illustrates an example of a user interface that is asking a user to input information prior to an input field being accessed (e.g., touched) in accordance with one embodiment of the present invention;

FIG. 3B illustrates the results of opening a keyboard without the use of the systems and methods of the present invention;

FIG. 3C illustrates an example of a user interface for a remote overlay displaying a soft keyboard and scroll bar in accordance with one embodiment of the present invention;

FIG. 4 is a sequence diagram illustrating operations for inserting text into a field in response to soft keyboard input in accordance with one embodiment of the present invention; and

FIG. 5 is a block diagram of a computer system upon which embodiments of the inventive subject matter can execute in accordance with one embodiment of the present invention.

### DETAILED DESCRIPTION OF THE INVENTION

In the following detailed description of example embodiments of the invention, reference is made to the accompanying drawings that form a part hereof, and in which is shown by way of illustration specific example embodiments in which the invention may be practiced. These embodiments are described in sufficient detail to enable those skilled in the art to practice the inventive subject matter, and it is to be understood that other embodiments may be utilized and that logical, mechanical, electrical and other changes may be made without departing from the scope of the inventive subject matter.

Some portions of the detailed descriptions which follow are presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, terms such as “processing” or “computing” or “calculating” or “determining” or “displaying” or the like, refer to the action and processes of a computer system, or similar computing device, that manipulates and transforms data represented as physical (e.g., electronic) quantities within the computer system's registers and memories into other data similarly represented as physical quantities within the computer system memories or registers or other such information storage, transmission or display devices.

In the figures, the same reference number is used throughout to refer to an identical component that appears in multiple figures. Signals and connections may be referred to by the same reference number or label, and the actual meaning will be clear from its use in the context of the description. In general, the first digit(s) of the reference number for a given item or part of the invention should correspond to the figure number in which the item or part is first identified.

The description of the various embodiments is to be construed as examples only and does not describe every possible instance of the inventive subject matter. Numerous alternatives could be implemented, using combinations of current or future technologies, which would still fall within the scope of the claims. The following detailed description is, therefore, not to be taken in a limiting sense, and the scope of the inventive subject matter is defined only by the appended claims.

The present invention is generally directed to various systems and methods that can provide an improved user typing experience when accessing a remote host device through a synchronization of typed texts between the user's mobile device and the remote host device. The systems and methods may, at the same time, allow the user to use the local soft keyboard on their mobile device instead of the keyboard of the remote host device.

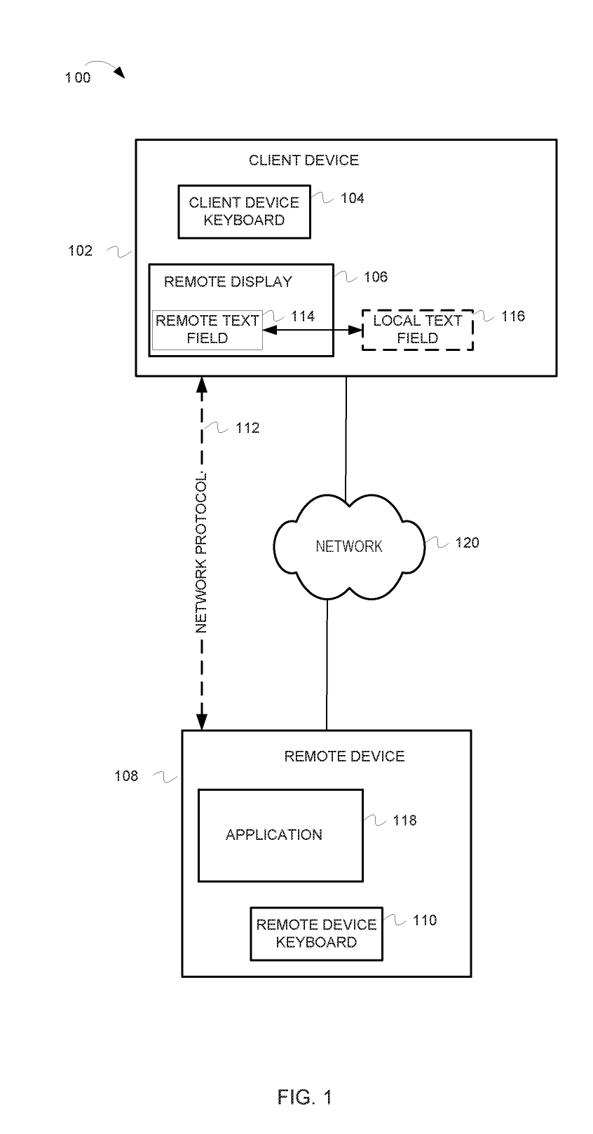

FIG. 1 is a schematic diagram illustrating a system 100 for providing a local keyboard on the local device for use in accessing the remote device. In some aspects, the system 100 includes a client device 102 and a remote device 108 communicably coupled via a network 120. The network 120 may be a local area network, a wide area network, an intranet, or other type of suitable network. In one embodiment, the network 120 is the internet.

The client device 102 can be any type of device having one or more processors to execute software programs. Examples of such devices include a desktop computer, a server computer, a laptop computer, a tablet computer, a mainframe computer, a smart phone, a personal digital assistant, a set top box, or any other computing devices capable of executing the methods described herein. Typically, the client device 102 will be a mobile device such as a laptop computer, a tablet computer or a smart phone. The client device 102 may be used to control a remote device 108 or an application 118 executing on a remote device 108.

The remote device 108 can also be any type of device having one or more processors. The remote device 108 comprises a computing device that is being controlled, or has an application executing on the remote device 108 that is being controlled, by client device 102. In some aspects, remote device 108 can be a physical device such as a desktop computer, a server computer, a laptop computer, a tablet computer, a mainframe computer, a smart phone, a personal digital assistant, a set top box, or any other computing device=. In an alternative embodiment, the remote device 108 can be a virtual device, e.g., running on a server by means of, but not limited to, emulation or virtualization.

The client device 102 includes a client device keyboard 104 that is an input device that a user typically uses to interact with input text fields on the client device 102. The client device keyboard 104 can be a physical keyboard (i.e., a hardware keyboard) or a soft keyboard.

A remote device keyboard 110 can be an input device that a user traditionally uses to interact with input text fields on the remote device 108, such as a virtual keyboard interface (non-visible), or an on-screen soft keyboard. This soft keyboard typically resides in the remote device 108. The remote device keyboard 110 is implemented such that when activated, the remote device keyboard 110 relays information about activated text fields to the client device 102 instead of showing a standard keyboard user interface (UI) on the remote device 108. Conversely, contents can be sent from the client device 102 to the remote device 108, where the remote device keyboard 110 provides text for text fields or other input fields on the remote device 108.

A remote display 106 comprises the contents of a screen of the remote device 108, as received and seen through the client device 102. The contents of the screen can be changed in real-time according to the interactions that are being input by the user from the client device 102, using sensors such as, but not limited to, touch input, location, accelerometer data, or output from applications 118 and components (not shown) executing on the remote device 108.

A network protocol 112 having a transport that is setup between the client device 102 and the remote device 108 for transmission or receipt information of the remote control in the system. The information includes, but is not limited to, touch input, location, accelerometer data, and the like.

A remote text field 114 comprises a text input field (not shown) present in the remote device 108, that is visible to the user through remote display 106, and that the user can interact with by for example, but not limited to, touching it, selecting a virtual keyboard button, changing the UI menu, typing a text, drawing, or the like. As this input field is actually not running in client device 102, touch events are detected locally on client device 102 and its position is relayed through network protocol 112 and further processed by the remote device 108 Operating Systems (OS) coupled with processors and memories to simulate the interaction.

A local text field 116 comprises the text input field present in the client device 102, that is not presented (i.e., is invisible) to the user, and acts as a local mirror on client device 102 of remote text field 114.

During operation of the above-identified system, the application 118 executing on the remote device 108 may require input text. The client device keyboard 104 is instantiated that can be used directly in the remote device 108. Use of the client device keyboard 104 in place of the remote device keyboard 110 can result in advantages for some embodiments or implementations. For example, the user will typically not be dependent on the quality of the network connection to interact with the keyboard while typing. Further, the user does not have to learn a completely new UI experience from the remote device keyboard 110, as there is a high probability that the remote device keyboard 110 will not be made by the same software vendor. Thus, the remote device keyboard 110 may have a different button layout or theme. Further, remote device keyboard 110 may have different correction, completion, suggestion or prediction algorithms Still further, the remote device keyboard 110 may not have knowledge of the typing behaviors of the user, thus requiring corrections that would otherwise be automatically provided to be manually provided until the remote device keyboard 110 has a better understanding of the user's typing behaviors.

Thus, replacing the remote device keyboard 110 with the client device keyboard 104 provides a novel mechanism for the user to be able to have the same experience with a remote application as if the user were typing into a regular client-side application.

Additionally, because the client device keyboard 104 interaction input does not depend on the remote connection, there is a benefit of instant haptic feedback such as vibration, sound or even enlarged keys that users typically rely on. Haptic feedback can be difficult to provide in a network environment and can make typing on a remote keyboard more difficult as the network round trip times are relatively large when compared to the person's typing speed.

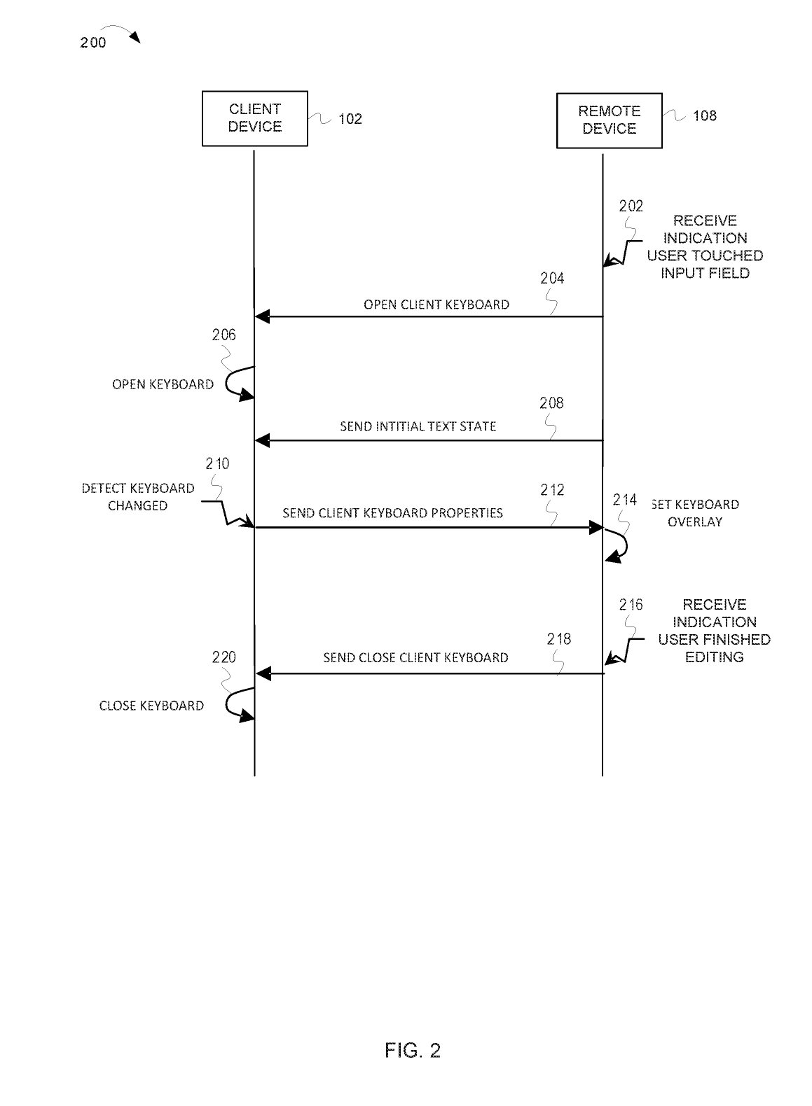

FIG. 2 is a sequence diagram 200 of an example initiation of a soft keyboard session and termination of the session. In order to avoid obfuscating the inventive subject matter, it is assumed that a streaming connection between the client device 102 and the remote device 108 is already established and running through the network protocol 112. For example, the client device 102 may provide an application that authenticates to a server (not shown) through login credentials (such as Active Directory). After being logged in, the user can be presented with a list of applications available on the remote server. When the user opens one of such applications (by tapping on it), a request is sent to the server, which provides a remote device 108 instance that is associated with that specific user, i.e., that contains the user's data storage (not shown). When the request is granted, the server returns to the client device 102 the necessary parameters for the client device 102 to connect to the remote device 108. When this streaming connection is established, the client device 102 can interact with a stream that visualizes the remote device 108. Those of skill in the art will appreciate that other means for establishing, whether now known or developed in the future, could be used to establish a streaming connection between the client device 102 and the remote device 108. The streaming connection accommodates a message proxy for inputs and outputs such as, but not limited to, the display and touch input.

At operation 202, the remote device 108 receives an indication that the user has begun an interaction with the remote text field. For example, the user may touch an area within the remote text field. When a text field is activated on the remote device 108, the keyboard relays information about the activated text field to the local device instead of showing a standard keyboard UI on the remote device. On the local device, based on the information received from the remote device, the system 100 activates a hidden text field which mimics the original text field (e.g., if the text input field on the remote device only accepts numbers as input, the hidden text field on the local device also only accepts numbers). Activating this hidden text field triggers the local keyboard of user's choice just like any other regular text field would. As user types, we transfer the content of the hidden text field to the remote device and our “dummy” keyboard populates the text field on the remote device.

At operation 204, the remote device 108 sends a message to the client device 102 to request that the client device 102 open the client device keyboard 104. In some aspects, the message can contain one or more input options. The input options can specify the remote text field 114 parameters. The parameters can include input type, type of action, additional navigation commands or a remote text field ID. As a non-limiting example, in the case of the input type, if the remote text field 114 expects a phone number, a number pad can be requested to client device 102. Similarly, if remote text field 114 expects an email address, a language-specific keyboard with easily accessible ‘@’ and ‘.com’ buttons can be requested. As a non-limiting example, in the case of additional navigation commands, Previous/Next buttons can be included to navigate a form. As a further non-limiting example, the type of action button can be Search, Done, Send, OK or Return. Finally, as a non-limiting example, the remote input field ID can contain a unique number, that can be used by the client device 102 to cache state throughout the lifecycle of the soft keyboard implementation.

At operation 206, the client device keyboard 104 is opened. In some aspects, as a local mirror of the remote text field 114, the local text field 116 is created using the received input options. The local text field 116 is invisible to the user. After the local text field 116 configured with the appropriate input options, a request is sent to the OS to focus on it, which in turn causes the client device keyboard 104 to be opened. From the user's perspective, touching the remote text field 114 opened the client device keyboard 104. As the client device keyboard 104 is now bound to the local text field 116, typing actions performed by the user can modify the invisible local text field 116 contents.

At operation 208, the remote device 108 sends a message containing an initial state of the remote text field 114. The message may contain one or more of the actual text of remote text field 114, the start/end position of the selection cursor, the start/end position of marked text, etc. As a non-limiting example, if the text of remote text field 114 is “Lorem ipsum dolor sit amet” and the user touched right at the end of the word “Lorem”, the start and end positions of the cursor would both be 5. In the case that “ipsum” is selected by long pressing the word, the start and end position would be 6 and 11, respectively. Marked text is typically used in Asian keyboard languages, such as Japanese or Korean, to visually enhance the current editing characters with a highlight.

At operation 210, the position and dimensions of the recently opened client device keyboard 104 are measured.

At operation 212, the positions and dimensions can be normalized and back to the remote device 108.

At operation 214, the remote device 108 can create a view (referred to herein as a remote overlay view (ROV)), where the ROV has the positions and dimensions received by the remote device 108 at the operation 212. In some aspects, the remote device keyboard 110 can provide the ROV. The ROV can be inserted into the display through a window manager (not shown) of the remote device 108. The ROV eventually becomes shadowed by the client device keyboard 104; however, the main advantage is that the window manager of the remote device 108 will attempt to make all UI components accessible. For example, the remote device 108 is not aware of the local client device keyboard 104, therefore it won't resize other user interface elements to make sure they are still fully visible. Providing the ROV forces this by creating a view on the remote device 108 that takes up the same size as the local client device keyboard 104. In effect, the remote device 108 is made to accommodate for the size of the local client device keyboard 104 when calculating the layout of user interface elements on remote device 108.

As a non-limiting example, if the remote device 108 is running the Android® OS, an input method editor (IME) can be implemented to show the ROV by overriding onCreateInputView( ) and returning a view with the local keyboard origin/size specifications.

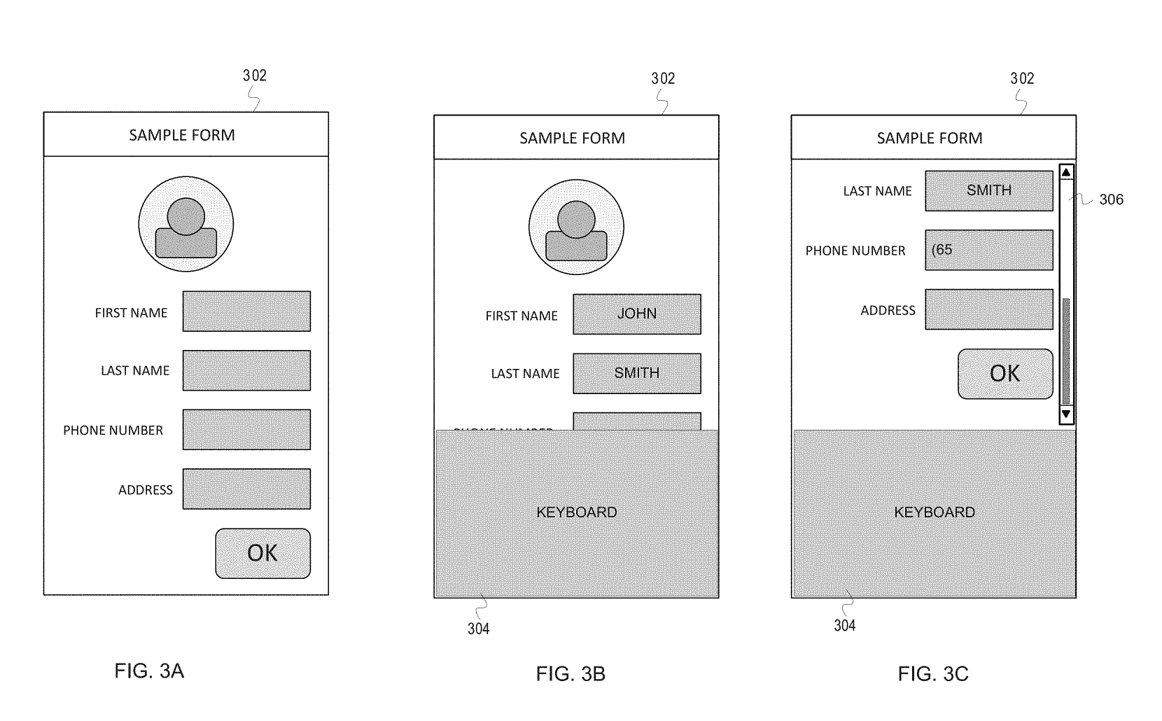

FIGS. 3A-3C illustrate examples of what the user experience would look like with and without the ROV. FIG. 3A shows an example UI view 302 that asks for the user input prior to an input field being accessed (e.g., touched).

FIG. 3B shows the results of opening a keyboard without the use of the systems and methods of the present invention. When touching an input field, a remote device keyboard 110 will popup. In the case illustrated in FIG. 3B, when the keyboard pops up, everything that is underneath the keyboard is not visible or accessible.

FIG. 3C illustrates the use of the systems and methods of the disclosure, including using the ROV to show a client device keyboard 104. Use of the ROV causes the Operating System to visibly focus on the selected text input, and further allows all other elements to be easily accessed by scrolling up or down via scroll bar 306.

Returning to FIG. 2, at operation 216, the remote device receives an indication that the user is finished editing, and that interaction with client device keyboard 104 is to end. For example, the user can submit an action, such as touching the ‘Return/Enter’ key to submit a form, or dismiss it by touching an outside area.

At operation 218, in response to ending the interaction with the client device keyboard 104, the remote device 108 sends a message to the client device 102 in order to request that the client device keyboard 104 be closed, thereby finishing the typing session.

At operation 220, the client device keyboard 104 is closed. In some aspects, the client device keyboard 104 can be closed by artificially unfocusing the previously mentioned local text field 116.

Various aspects of the present invention can address issues regarding the interaction between the client device 102 and the remote device 108 during a typing session. For example, in some aspects, every time a user performs an action with the client device keyboard 104, such as but not limited to, inputting a character, deleting a character/word, accepting a suggestion or keyboard auto-corrects, only the differences in the text before and after the operation are transmitted to the remote device 108.

Additionally, not only can the client device keyboard 104 change the text, but also the input text field can be changed remotely by remote device's 108 underlying Operating System. As a non-limiting example, an email application could automatically surround a user input email address with ‘<’ and ‘>’ symbols after the user types a comma. As another non-limiting example, when inputting a phone number in a form, the OS can add parenthesis/dashes/spaces to format the numbers, such as automatically changing from “1234567890” to “(123) 456 7890”.

However, as mentioned above, user actions on the keyboard affect the local text field 116 mirror of the remote text field 114. Thus, in some aspects of the present invention, a mechanism is provided to keep the local text field 116 and the remote text field 114 in sync so that the user sees the expected content in the remote display 106 as he or she is typing using the client device keyboard 104.

In some aspects of the present invention, the local text field 116 and the remote text filed 114 are kept in sync using a collaborative text editing techniques. Traditionally, collaborative text editing tools keep a document in sync across a number of clients and a common server, while being edited by multiple users at the same time. In the case of the systems and methods of the present invention, collaborative text editing algorithms are applied as a one client, one server application. In some aspects of the present invention, the local text field 116 and the remote text filed 114 are kept in sync using an Operational Transformation algorithms. Details on the Operational Transformation algorithms can be found in the document C. A. Ellis and S. J. Gibbs. 1989, Concurrency Control in Groupware Systems, In Proceedings of the 1989 ACM SIGMOD International Conference on Management of data (SIGMOD '89), ACM, New York, N.Y., USA, 399-407, which is incorporated by reference herein for all purposes. In alternative aspects of the present invention, the local text field 116 and the remote text filed 114 are kept in sync using Differential Synchronization algorithms. Details on Differential Synchronization can be found in the document N. Fraser. 2009, Differential Synchronization, In Proceedings of the 2009 ACM DOCENG Symposium on Document Engineering (DOCENG '09), The Association for Computing Machinery, 2 Penn Plaza, Suite 701, New York, N.Y. 10121-0701, pp. 13-20, which is incorporated by reference herein for all purposes.

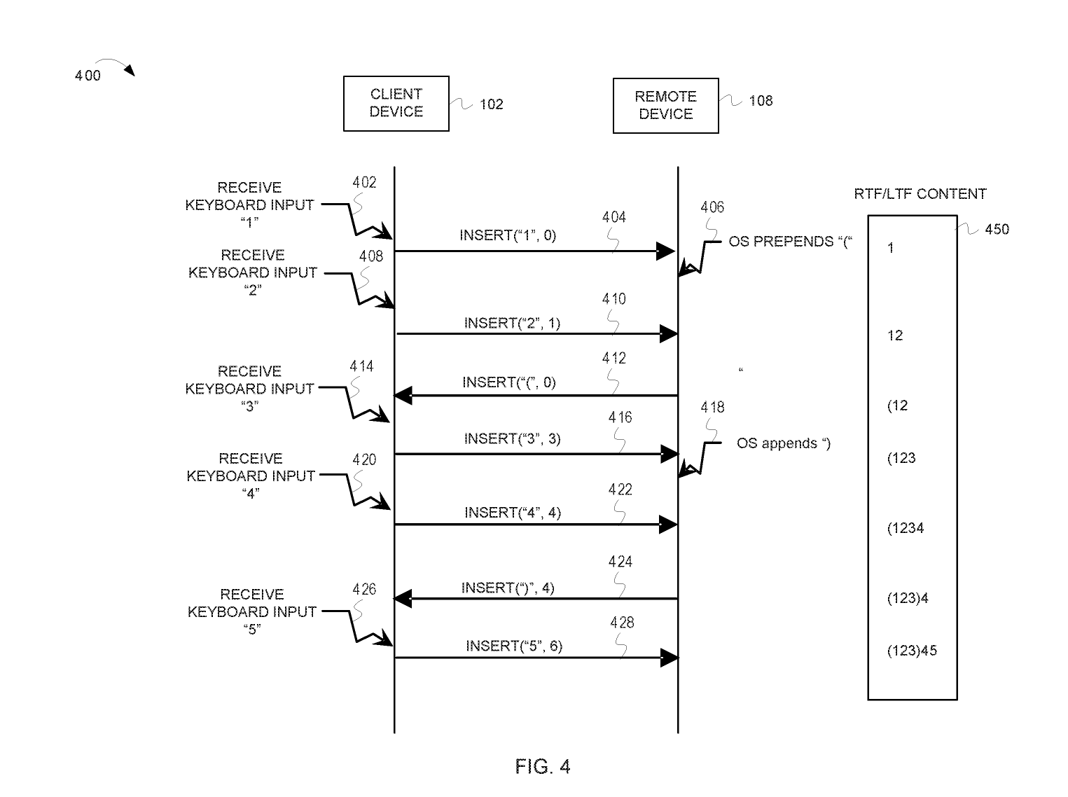

FIG. 4 is a sequence diagram 400 illustrating example operations for inserting text into a field in response to soft keyboard input. For the purposes of the example, insertion of characters into the “Number” field of the example screen shown in FIG. 3C is illustrated. The sequence diagram assumes that the remote text field 114 initially specifies the client device keyboard 104 to open with an input type of number, effectively configuring it as a number pad. Furthermore, as the client device keyboard 104 opens, the ROV is put in place, and the local text field 116 waits for the input. The contents of the local text field 116 and the remote text field 114 after the various operations described below are indicated by RTF/LTF content 450.

At operation 402, the client device 102 receives an indication that the user typed a “1” using the client device keyboard 104. The local text field 116 is modified by that value.

At operation 404, a transform operation is created and relayed to the remote device 108 through the network protocol 112, and applied to the remote text field 114. As the remote text field 114 started as empty, its text state becomes “1”.

Shortly after the remote text field 114 applies “1”, at operation 406, the application that is serving the remote text field 114 automatically prepends “(” to beautify the input for the user by instructing the OS through a well-defined remote text field 114 API.

At operation 408, the client device 102 receives an indication that the user typed a “2” using client device keyboard 104. The local text field 116 can be modified by that value.

At operation 410, a transform operation is created and relayed to the remote device 108 through the network protocol 112, and applied to the remote text field 114. The RTF/LTF text state becomes “12”.

At operation 412, a transform operation is created and relayed to the client device 102 through the network protocol 112, and applied to the local text field 116. Although this last action is not visible to the user (local text field 116 is invisible), the underlying the client device keyboard 104 implementation becomes aware of it, which can consequently take it into consideration when calculating its prediction algorithms. It can be effective solution to resolve the problem of providing local auto-correction, suggestions or auto-replacements of text to the user. After this transform, the RTF/LTF text state is “(12”.

Finally, the rest of the interaction from the figure or any other use case is done in a similar fashion using a combination of inserting, deleting and updating operations that are of the scope of above mentioned algorithms and illustrated as operations 414-428.

As will be apparent from the above, there can be conflicts in the text of the remote text field 114 and the local text field 116. In some aspects, in order to resolve conflicts, the server version takes precedence over the client version. This is desirable as the server version contains the text that is effectively shown to the user, through the remote display 106.

It should be noted that the systems and method described above can also be applied to devices that have a physical keyboard as well. In such a case, operations associated with opening/closing of the keyboard and the overlay view of the workflow can be ignored. Although typical approaches involving physical keyboard do not suffer from haptic feedback or different UI issues, the user experience can still be improved by giving the user the local auto-correction, suggestions or auto-replacements of text from client device 102 to remote device 108 as they have in local applications.

As will be appreciated from the above, the systems and methods of the present invention, a soft keyboard is provided that can improve a user's experience when a user accesses a remote mobile device. The local device keyboard is utilized to interact with input text fields that otherwise have been resolved by simply using an inconvenient remote soft keyboard. In some aspects, advantages can be achieved by using the local device keyboard, such as leveraging a seamless experience between local and remote applications during typing, utilizing the auto-correction and suggestions, and having better local customizable keyboard appearance and haptic feedback.

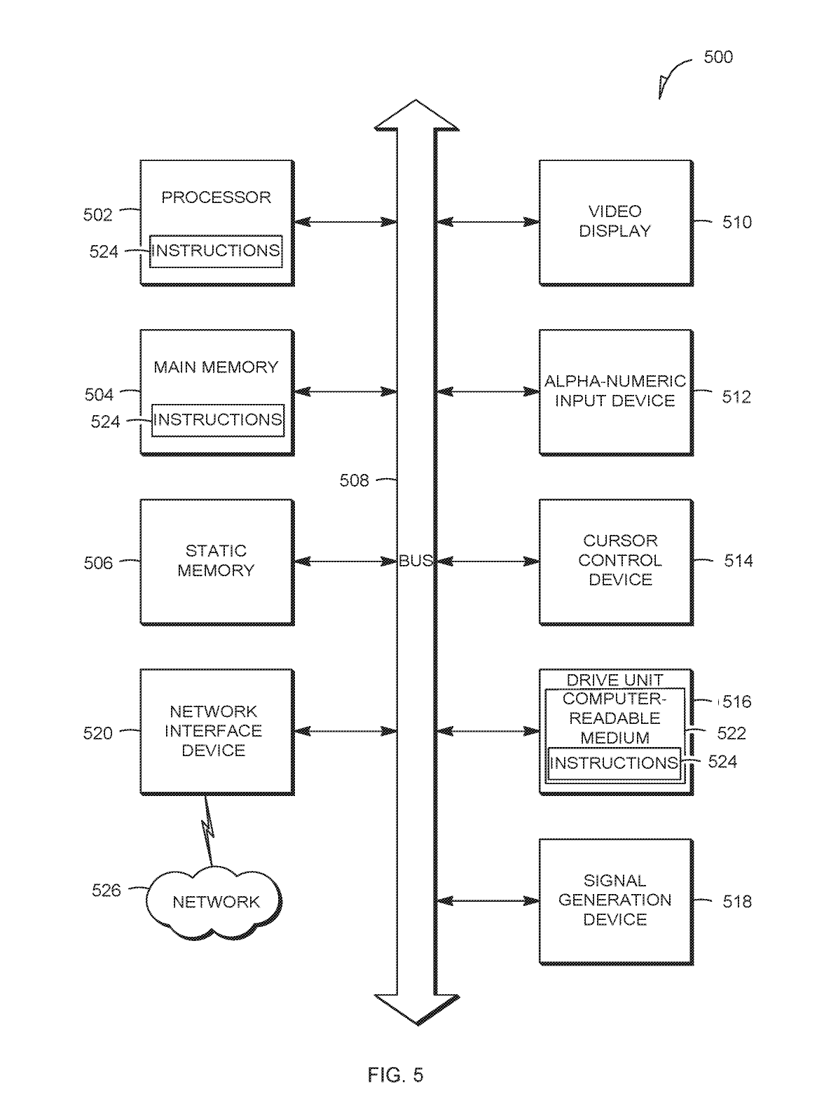

FIG. 5 is a block diagram of an example embodiment of a computer system 500 upon which embodiments of the inventive subject matter can execute. The description of FIG. 5 is intended to provide a brief, general description of suitable computer hardware and a suitable computing environment in conjunction with which the invention may be implemented. In some embodiments, the inventive subject matter is described in the general context of computer-executable instructions, such as program modules, being executed by a computer. Generally, program modules include routines, programs, objects, components, data structures, etc., that perform particular tasks or implement particular abstract data types.

Moreover, those skilled in the art will appreciate that the aspects of the disclosure may be practiced with other computer system configurations, including hand-held devices, multiprocessor systems, microprocessor-based or programmable consumer electronics, smart phones, network PCs, minicomputers, mainframe computers, and the like. Aspects of the disclosure may also be practiced in distributed computer environments where tasks are performed by I/O remote processing devices that are linked through a communications network. In a distributed computing environment, program modules may be located in both local and remote memory storage devices.

With reference to FIG. 5, an example embodiment extends to a machine in the example form of a computer system 500 within which instructions for causing the machine to perform any one or more of the methodologies discussed herein may be executed. In alternative example embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. Further, while only a single machine is illustrated, the term “machine” shall also be taken to include any collection of machines that individually or jointly execute a set (or multiple sets) of instructions to perform any one or more of the methodologies discussed herein.

The example computer system 500 may include a processor 502 (e.g., a central processing unit (CPU), a graphics processing unit (GPU) or both), a main memory 504 and a static memory 506, which communicate with each other via a bus 508. The computer system 500 may further include a video display unit 510 (e.g., a liquid crystal display (LCD) or a cathode ray tube (CRT)). In example embodiments, the computer system 500 also includes one or more of an alpha-numeric input device 512 (e.g., a keyboard), a user interface (UI) navigation device or cursor control device 514 (e.g., a mouse), a disk drive unit 516, a signal generation device 518 (e.g., a speaker), and a network interface device 520.

The disk drive unit 516 includes a machine-readable medium 522 on which is stored one or more sets of instructions 524 and data structures (e.g., software instructions) embodying or used by any one or more of the methodologies or functions described herein. The instructions 524 may also reside, completely or at least partially, within the main memory 504 or within the processor 502 during execution thereof by the computer system 500, the main memory 504 and the processor 502 also constituting machine-readable media.

While the machine-readable medium 522 is shown in an example embodiment to be a single medium, the term “machine-readable medium” may include a single medium or multiple media (e.g., a centralized or distributed database, or associated caches and servers) that store the one or more instructions. The term “machine-readable medium” shall also be taken to include any tangible medium that is capable of storing, encoding, or carrying instructions for execution by the machine and that cause the machine to perform any one or more of the methodologies of embodiments of the present invention, or that is capable of storing, encoding, or carrying data structures used by or associated with such instructions. The term “machine-readable storage medium” shall accordingly be taken to include, but not be limited to, solid-state memories and optical and magnetic media that can store information in a non-transitory manner, i.e., media that is able to store information. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks.

The instructions 524 may further be transmitted or received over a communications network 526 using a signal transmission medium via the network interface device 520 and utilizing any one of a number of well-known transfer protocols (e.g., FTP, HTTP). Examples of communication networks include a local area network (LAN), a wide area network (WAN), the Internet, mobile telephone networks, Plain Old Telephone (POTS) networks, and wireless data networks (e.g., WiFi and WiMax networks). The term “machine-readable signal medium” shall be taken to include any transitory intangible medium that is capable of storing, encoding, or carrying instructions for execution by the machine, and includes digital or analog communications signals or other intangible medium to facilitate communication of such software.

Although an overview of the inventive subject matter has been described with reference to specific example embodiments, various modifications and changes may be made to these embodiments without departing from the broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

As is evident from the foregoing description, certain aspects of the inventive subject matter are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the spirit and scope of the inventive subject matter. Therefore, it is manifestly intended that this inventive subject matter be limited only by the following claims and equivalents thereof.

The Abstract is provided to comply with 37 C.F.R. §1.72(b) to allow the reader to quickly ascertain the nature and gist of the technical disclosure. The Abstract is submitted with the understanding that it will not be used to limit the scope of the claims.

1. A method for providing a keyboard for a remote device, the method comprising the steps of:
establishing a network connection between the remote device and a client device;
receiving an indication that a keyboard is needed for the remote device communicably coupled to the client device;
in response to receiving the indication, opening a soft keyboard on the client device; and
transmitting text received via the soft keyboard on the client device to the remote device.

2. The method of claim 1 further comprising the steps of:
receiving, by the remote device, position and dimension information for the soft keyboard on the client device; and
establishing, on the remote device, a remote overlay view in accordance with the position and dimension information, the remote overlay view configured to display the soft keyboard of the client device.

3. The method of claim 1, wherein the step of establishing the remote network connection further comprises:
authenticating the user accessing the remote network through a remote server coupled to the client device; and
sending a streaming request to the remote server for interacting with an application executing on the remote device.

4. The method of claim 1 further comprising the step of creating a local text field on the client device that mirrors a remote text field on the remote device, the local text field being hidden from display.

5. The method of claim 4 further comprising the step of synchronizing content of the local text field and the remote text field.

6. The method of claim 5, wherein the step of synchronizing the content of the local text field and the remote text field comprises applying one or both of differential synchronization algorithms or operational transformation algorithms to the local text field and the remote text field.

7. A system for providing a virtual keyboard in a remote network connection environment, the system comprising:
a client device having computing processor operable to display a local keyboard image coupled to the remote network connection;
a remote device having a computing processor and an application for executing remote access the virtual keyboard coupled to the remote network connection; and
a remote server for storing an instance associated with a specific user and providing the remote device with such instance.

8. The system of claim 7, wherein the client device further comprises a remote display for displaying contents of a screen of the remote device.

9. The system of claim 8, wherein the client device further comprises a local text field, and wherein the local text field is synchronized with the remote text field.

10. The system of claim 9, wherein the local text field includes at least one of a scaler, matrices, and image mirrors coupled with the remote server.

10. (canceled)

11. A non-transitory computer readable storage medium having a program stored thereon, the program causing a computer to execute the steps of:
establishing a network connection between the remote device and a client device;
receiving an indication that a keyboard is needed for the remote device communicably coupled to the client device;
in response to receiving the indication, opening a soft keyboard on the client device;
transmitting text received via the soft keyboard on the client device to the remote device;
receiving, by the remote device, position and dimension information for the soft keyboard on the client device; and
establishing, on the remote device, a remote overlay view in accordance with the position and dimension information, the remote overlay view configured to display the soft keyboard of the client device.
